(19) United States
(12) Patent Application Publication
(10) Pub. No.: US 2019/0310741 A1
(43) Pub. Date: Oct. 10, 2019

(54) ENVIRONMENT-BASED ADJUSTMENTS TO USER INTERFACE ARCHITECTURE

(71) Applicant: Microsoft Technology Licensing, LLC, Redmond, WA (US)

(72) Inventors: Priya GANADAS, Seattle, WA (US); Jamie R. CABACCANG, Bellevue, WA (US); Jennifer Jean CHOI, Seattle, WA (US)

(21) Appl. No.: 15/946,551

(22) Filed: Apr. 5, 2018

(51) Int. Cl. G06F 3/0482; G06F 3/0483; G06F 3/0484

(52) U.S. Cl. CPC G06F 3/0482; G06F 3/04847; G06F 3/0483

(57) ABSTRACT

The herein described technology facilitates auto-adjustments to UI architecture of content displayed on an electronic device based on content collected from a three-dimensional scene. A method for adjusting UI architecture includes collecting scene data from a three-dimensional scene and selecting a content presentation option of multiple selectable content presentation options based on the collected scene data, where each of the multiple selectable content presentation options defines a different selection of content to present within an application window of the electronic device. The method further includes presenting the content selection defined by the selected content presentation option within the application window on a display of the electronic device.

### BACKGROUND

Large-screen display devices have become common in many different settings for a variety of purposes. Many homes have large-screen entertainment devices with smart features such as voice recognition, offices have replaced marker boards and traditional white-screen projectors with large LED screens, and places such as shopping malls and airports may utilize large-screen smart technology to display advertisements or maps, some with interactive touch features. Many of these newer large-screen devices are capable of collecting information from a surrounding environment in multiple ways, such as through such as touch-screen displays, microphones, and/or cameras.

Despite this growing versatility in large-screen device functionality, there exist certain scenarios where the use of such devices remains burdensome to a user. For example, densely arranged content on a large screen display may be difficult to see, particularly if the display screen is far away from the audience. In cases where users have the ability to adjust the size or format of content displayed, such adjustments are performed manually and tediously, such as asking the audience to confirm whether the projected text is “big enough” and then providing a keystroke to increase font size and/or interacting with a touch screen (e.g., pinching to zoom in or out, dragging to adjust window sizes, etc.). In still other use scenarios, large-screen touch-interactivity features are difficult to fully leverage due to constraints on the physical reach of individuals such as height and arm length, hindering access to certain parts of the display screen.

### SUMMARY

A method for adjusting UI architecture includes collecting scene data from a three-dimensional scene and selecting a content presentation option of multiple selectable content presentation options based on the collected scene data. In one implementation, each of the multiple selectable content presentation options defines a different selection of content to present within an application window of the electronic device. The method further provides for presenting the content selection defined by the selected content presentation option within the application window on a display of the electronic device.

This Summary is provided to introduce an election of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following more particular written Detailed Description of various implementations and implementations as further illustrated in the accompanying drawings and defined in the appended claims.

### BRIEF DESCRIPTION OF THE DRAWINGS

FIG. 1 illustrates an example processing device with features for self-regulating user interface (UI) architecture.

FIG. 2 illustrates aspects of an example system with features for self-regulating UI architecture based on sensed environmental attributes of a three-dimensional scene.

FIG. 3 illustrates another example processing device with features for self-regulating UI architecture based on sensed environmental attributes of a three-dimensional scene.

FIG. 4 illustrates example operations for self-regulating UI architecture based on sensed environmental attributes of a three-dimensional scene.

FIG. 5 illustrates an example schematic of a processing device suitable for implementing aspects of the disclosed technology.

### DETAILED DESCRIPTION

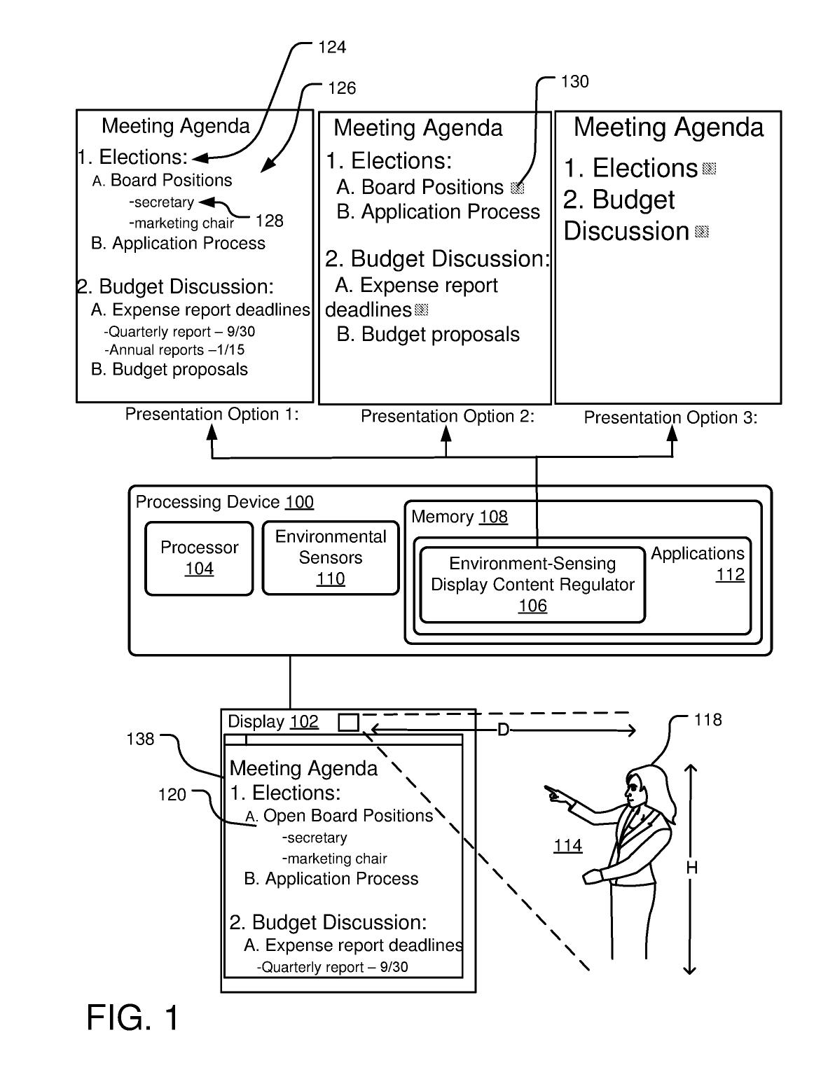

FIG. 1 illustrates an example processing device 100 with features for self-regulation of user interface (UI) architecture. As used herein, “UI architecture” refers to one or more of the arrangement, selection, and presentation of application window content. Application window content includes content presented within an application window including, for example, user-generated content and application UI elements, such as menu items and other user-selectable items designed to convey user inputs to an application.

The processing device 100 includes a display 102 and environmental sensors 110 for collecting data from a surrounding environment to gather information about a three-dimensional scene 114. In FIG. 1, the processing device 100 is shown to be a large-screen device, such as a wall-mounted display device. In different implementations, however, the processing device 100 may take on a variety of forms and serve a variety of functions.

In one implementation, the processing device 100 is a device designed for use in an office workplace, such as a device used to present information and/or serve as an interactive workspace (e.g., a touchscreen whiteboard). In other implementations, the processing device 100 is a publicly-used device, such as a kiosk, vending machine, or an interactive store display or map (e.g., an airport map). In still other implementations, the processing device 100 is an entertainment device, such as a smart TV or gaming console coupled to a display. Notably, several of the examples described herein pertain to devices with touch-screen interface capability; however, there exist some applications for the disclosed technology in processing devices with displays lacking touch-sense capability.

During active operations of the processing device 100, the environmental sensors 110 collect scene data from the three-dimensional scene 114. Example environmental sensors include without limitation one or more sensors for image and/or video capture, sound capture, depth mapping, proximity detection, touch sensitivity, and other sensing capabilities. In different implementations, the environmental sensors 110 may vary in number and form.

Data collected by the environmental sensors 110 is analyzed by an environment-sensing display content regulator 106, which performs tasks for automatically adjusting application window content and/or selecting a subset of application window content for display based on an analysis of data collected by the environmental sensors 110. In FIG. 1, the environment-sensing display content regulator 106 is stored locally in memory 108 along with one or more other applications 112 and executed by a processor 104 of the processing device 100. In some implementations, different operations of the environment-sensing display content regulator 106 are performed by different processors and/or on one or more processing devices external to the processing device 100. For example, some operations of the environment-sensing display content regulator 106 may be performed remotely, such as by a server coupled to the processing device 100 via a web-based connection. In still other implementations, the display 102 is a device separate from a device executing the environment-sensing display content regulator 106. For example, the environment-sensing display content regulator 106 may be executed by a gaming console that is coupled to an external monitor serving as the display 102.

In one implementation, the environment-sensing display content regulator 106 is part of an operating system (not shown) of the processing device 100. As part of the operating system, the environment-sensing display content regulator 106 automatically adjusts UI elements for a variety of different applications that execute with support of the operating system. In other implementations, the environment-sensing display content regulator 106 is an application plugin designed to operate with one or more specific individual applications, such as application(s) that support note-taking or presentation functionality (e.g., slide deck presentation, co-presence whiteboard collaboration).

The environment-sensing display content regulator 106 analyzes the received environmental data to monitor the three-dimensional scene 114 for certain conditions, referred to herein as environmental attribute conditions, that trigger adjustments to UI architecture. Environmental attributes conditions are based on properties (“environmental attributes”) of a surrounding environment such as room dimensions, objects in the room, and user presence factors. As used herein, “user presence factors” refer to physical characteristics of a user, such as characteristics that describe appearance of a user, location of a user, or motion of a user (e.g., user actions). For example, user presence characteristics may include factors such as the number of users in the three-dimensional scene 114, the height of one or more users, the distance of one or more users from the display 102, the length of time that one or more users have been in a stationary location and/or proximity of the display, the velocity of the users, gestures of one or more users and/or physical characteristics such as gender, approximate age, etc.

In some implementations, the environment-sensing display content regulator 106 continuously receives the environmental data during execution of one or more of the applications 112; in other implementations, the environment-sensing display content regulator 106 receives the environmental data responsive to certain device tasks, such as responsive to the launch of an application or responsive to a user instruction for initiating an auto-adjust of UI architecture elements or format.

In different implementations, the environment-sensing display content regulator 106 may utilize different types of the environmental data to identify environmental attributes of the three-dimensional scene 114. For example, the environment-sensing display content regulator 106 may utilize depth mapping information to determine the dimensions between the display 102 and various objects and/or distances between objects. A depth map of the three-dimensional scene 114 may be derived in various ways, such as by using optical sensors that measure time-of-flight of light rays projected and bounced off of different objects or by measuring deformation of various patterns of structured light projected into objects present in the three-dimensional scene 114. In addition to or in lieu of depth map information, camera data can be used to determine other environmental attributes such as the number of living and non-living subject in a room, the height of each subject, and other physical characteristics of subject. In some implementations, the environment-sensing display content regulator 106 employs image recognition techniques, such as machine-learning algorithms training, to identify information such as the gender of the subjects, age of the subjects (e.g., whether the subjects are adults or children), and/or to identify actions or gestures made by the subjects.

After analyzing the environmental attributes within the three-dimensional scene 114, the environment-sensing display content regulator 106 selectively adjusts UI architecture by selecting one of multiple selectable content presentation options for the application window content. In different implementations, the multiple selectable content presentation options may provide for one or more of content selection, content arrangement, and/or content formatting of application window content (e.g., user-generated content and/or UI elements of the application window 138).

In the illustrated example, the environment-sensing display content regulator 106 identifies three different selectable content presentation options (e.g., Content Presentation Option 1; Content Presentation Option 2; and Content Presentation Option 3) that each define a different subset of user-generated content within a document 120 for which an associated viewing application is initiating presentation in an application window 138.

In FIG. 1, the processing device 100 has received an instruction to present the application window 138 and to display the document 120 within the application window 138. The document 120 is a user-generated document including a meeting agenda, formatted as an outline with numbers to denote main topics (e.g., a main topic 124), letters to denote sub-topics (e.g., a sub-topic 126), and punctuation (e.g., hyphens) to denote sub-sub-topics (e.g., a sub-sub topic 128). The environment-sensing display content regulator 106 assesses the content associated with the application window 138 and identifies multiple available content presentation options as well as one or more environmental attribute conditions defined in association with each of the content presentation options. In this example, the environment-sensing display content regulator 106 identifies Presentation Content Option 1, Presentation Content Option 2, and Presentation Content Option 3, which each provide for varying views of the outline—e.g., fully expanded, partially condensed, and fully condensed views of the outline.

Each of the multiple selectable content presentation options is associated in memory with one or more environmental attribute conditions. The environment-sensing display content regulator 106 assesses the three-dimensional scene 114 for the satisfaction of each of these environmental attribute conditions and selects one of the multiple content presentation options based on the satisfaction or non-satisfaction of such conditions.

In the illustrated example, each of the multiple selectable content presentation options is associated with an environmental attribute condition defining a different value range for a measurable environmental attribute ‘D,’ representing a distance between the display 102 and the meeting participant 118 (e.g., the closest user in the room). The environment-sensing display content regulator 106 determines the distance ‘D’ and compares this measured distance to each of multiple stored thresholds to select one of the content presentation options.

When the measured distance ‘D’ is less than a first threshold, the environment-sensing display content regulator 106 selects Presentation Content Option 1, causing the processing device 100 to display all data in the document 120. The first threshold may, for example, be based on a proximity that is calculated or presumed sufficient to enable a person with average eyesight to read and decipher all of the applicant window content that of the document 120.

When the measured distance ‘D’ is greater than the first threshold but smaller than a second larger threshold, the environment-sensing display content regulator 106 selects Presentation Content Option 2, causing the processing device 100 to display fewer than all of the content elements in the document 120 and to display those content elements at a larger size than the corresponding size of the same elements in Presentation Content Option 1. Here, the processing device 100 displays the main topics (e.g., the main topic 124) and the sub-topics (e.g., the sub-topic 126) but omits the sub-sub topics (e.g., the sub-sub topic 128).

When the measured distance ‘D’ exceeds both the first threshold and the second larger threshold, the environment-sensing display content regulator 106 selects Presentation Content Option 3 and the processing device 100 displays a smallest subset of the content elements present within the document 120 and at a larger size than the corresponding sizes of the same elements in Presentation Content Options 1 and 2. In this scenario, the processing device 100 displays exclusively the main topics (e.g., the main topic 124), while omitting the sub-topics (126) and sub-sub topics (128). This presentation option may, for example, be ideal for scenarios where users within the three-dimensional scene 114 are at considerably large distance(s) from the display 102.

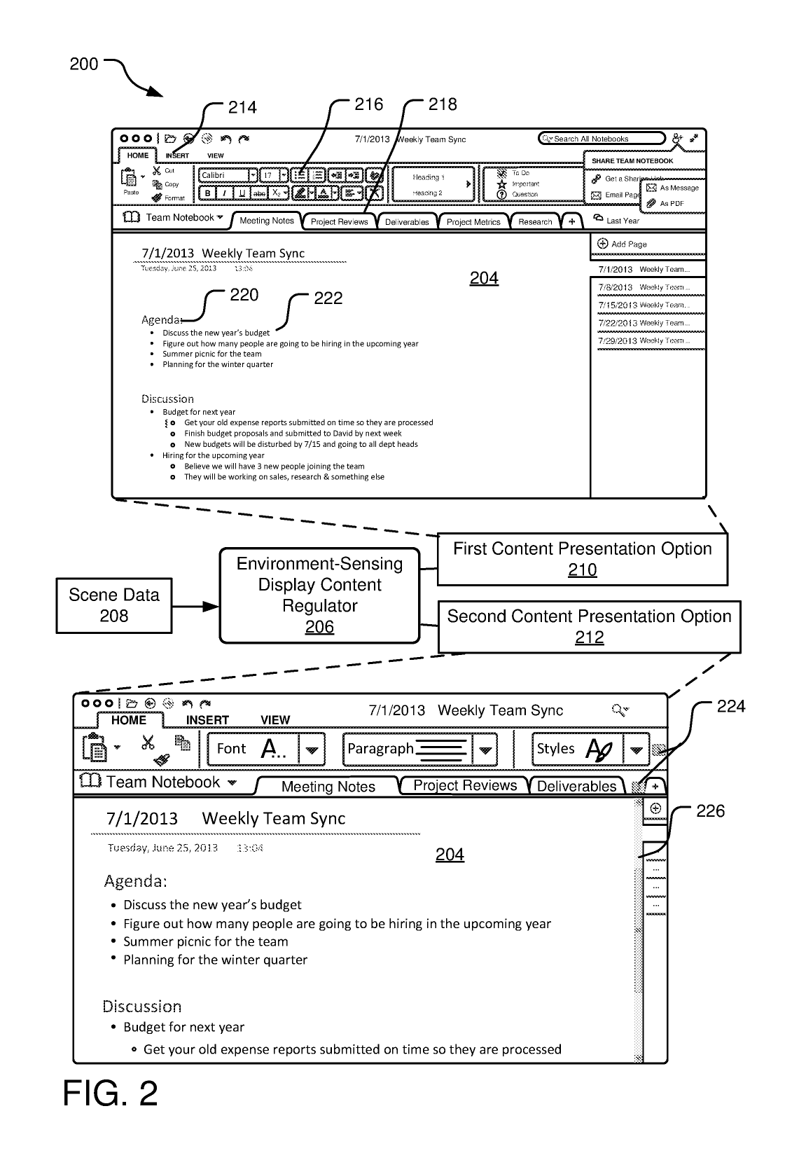

In some implementations, the multiple selectable content presentation options may provide for variation in the placement and/or selection of application UI elements (e.g., application menu options, graphics, etc.) rather than merely the user-created content elements within a document, as shown in FIG. 1. For example, the multiple selectable content presentation options may provide for different selections and/or arrangements of application menu items and/or the additions of graphics or tools to ease navigation of the UI application elements and user-created content (such as the addition of a selectable expansion button 130). One example of content presentation options pertaining to different selections and arrangements of application menu items is discussed with respect to FIG. 2.

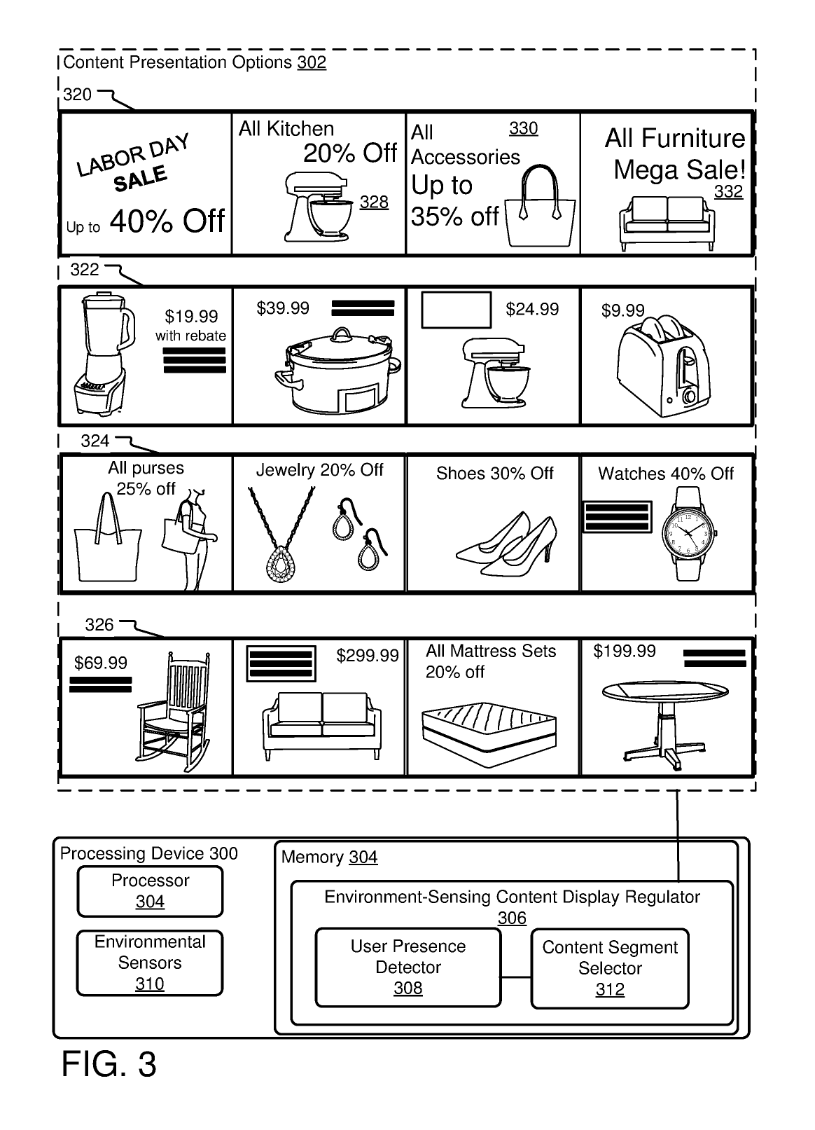

In still other implementations, the multiple content presentations provide for presentation of different types of content, such as for presenting different documents or different portions of documents responsive to detection of certain environmental attributes within the three-dimensional scene 114. For example, the multiple content presentation options may include different content loops of advertising content, as detailed in the example described with respect to FIG. 3, below.

In other implementations, the different content presentation options correspond to different arrangements of recognized UI elements. For example, the environment-sensing display content regulator 106 may present some of the content elements in the document 120 at a lower or higher height based on a detected height of the meeting participant 118. Height-based content arrangement selections may be particularly useful in implementations where the display 102 is a touch screen and one or more users are interacting with the touch screen to modify information within the document 120.

Although the example of FIG. 1 involves a single detected user within the three-dimensional scene 114, the environment-sensing display content regulator 106 may, in other implementations, select one of the content presentation options based on a calculated distance between the display 102 and multiple users in the three-dimensional scene 114. For example, the environment-sensing display content regulator 106 may select the content presentation option based on an average distance to each detected user. In still another example implementation, the environment-sensing display content regulator 106 selects a content presentation option based on the detected dimensions of a room. For example, the environment-sensing display content regulator 106 selects a content presentation option with fewer and/or larger content elements when the dimensions of the room exceed a predefined threshold and a content presentation option with more and/or smaller content elements when the dimensions of the room do not exceed the predefined threshold.

FIG. 2 illustrates aspects of an example system 200 with features for self-regulating UI architecture based on sensed environmental attributes of a three-dimensional scene. The system 200 includes an environment-sensing display content regulator 206 that receives and analyzes scene data 208 from one or more environmental sensors (not shown) of a processing device (not shown). The environment-sensing display content regulator 206 analyzes the scene data 208 to identify environmental attributes of the scene (e.g., one or more user presence factors) and selects between multiple selectable content presentation options for displaying application window content based on the identified environmental attributes of the scene. Specific aspects of the environment-sensing display content regulator 206 not described herein may be the same or similar to the environment-sensing display content regulator 106 described with respect to FIG. 1.

In FIG. 2, the application window content includes a window of a note-taking application and a saved user document 204 that was previously created by the note-taking application. In one implementation, the environment-sensing display content regulator 206 initiates content selection and formatting actions responsive to receipt of an instruction from the note-taking application, such as in response to an initial launch of the note-taking application. In another implementation, the environment-sensing display content regulator 206 initiates the content selection and formatting actions responsive to an instruction received from an operating system of an associated processing device. In still another implementation, environment-sensing display content regulator 206 initiates the content selection and formatting actions responsive to a user's selection of a menu item providing an option for recalibrating and/or auto-adjusting UI architecture within an application.

In the illustrated example, the application window content includes both UI elements of the note-taking application (e.g., menus such as a menu 214, selectable menu items as a button 216, and organizational tabs such as an organizational tab 218) and UI elements of the user document 204 (e.g., headers such as a header 220 and bullet items such as a bullet item 222).

The environment-sensing display content regulator 206 identifies multiple selectable content presentation options pertaining to the application window content. In one implementation, the environment-sensing display content regulator 206 identifies multiple selectable content presentation options by accessing one or more templates specific to the note-taking application that define different selections and/or arrangements of the UI elements of the note-taking application. The various templates may be further associated with different rules pertaining to the presentation of user-generated content within the user document 204, such as rules for the inclusion or exclusion of certain user-generated content elements (e.g., header elements, graphics, body text blocks) as well as rules for the arrangement and general presentation (e.g., size) of such elements.

In FIG. 2, the environment-sensing display content regulator 206 identifies a first content presentation option 210 and a second content presentation option 212 as two selectable content presentation options associated with different environmental attributes observable within the scene data 208. The first content presentation option 210 is a more detailed, zoomed-out view of the content pending presentation. The second content presentation option 212 is, in contrast, a less-detailed, zoomed-in view of some of the same application window content. The first content presentation option 210 shows the UI elements of the user document 204 in a smaller font than the corresponding elements in the second content presentation option 212. Due to this sizing difference, the second content presentation option 212 shows a smaller subset of the UI elements in the user document 204 than the first content presentation option 210. Additionally, the two content presentation options include different selections and arrangements of user-generated content elements of the note-taking application. For instance, the first content presentation option 210 includes a greater number of organization tabs (e.g., 218) and a greater number of selectable menu items (e.g., 216). These items are also presented in a smaller size within the first content presentation option 210 than within the second content presentation option 212.

Notably, the second content presentation option 212 includes some content items that are not included in the first content presentation option 210, such as expansion tabs 224 and a scroll bar 226, which are added by the environment-sensing display content regulator 206 in order to simplify user interaction with the application window and the user document 204.

The environment-sensing display content regulator 206 selects between the two identified content presentation options—a first content presentation option 210 and a second content presentation option 212—based on environmental attributes recognized from the scene data 208. In one implementation, the environment-sensing display content regulator 206 selects the first content presentation option 210 if the scene data 208 indicates that users are within a threshold proximity of an associated display (not shown) and selects the second content presentation option 212 if the scene data 208 indicates that there are no users within the threshold proximity of the display. In another implementation, the environment-sensing display content regulator 206 selects the first content presentation option 210 if the scene data 208 indicates that the surrounding room is smaller than a threshold and selects the second content presentation option 212 if the scene data 208 indicates that the surrounding room is larger than the threshold.

In yet another implementation, the environment-sensing display content regulator 206 selects between the first content presentation option 210 and the second content presentation option 212 based on the identity of a user present in the scene (e.g., as captured by voice or imagery in the scene data). For example, a near-sighted user may set an account preference to default UI architecture to the most-magnified option available (e.g., the second content presentation option 212).

In some implementations, the environment-sensing display content regulator 206 may execute voice or facial recognition logic to identify user(s) present in the scene. If the environment-sensing display content regulator 206 recognizes a user in the scene that also has an account on the device (such as the near-sighted user), the environment-sensing display content regulator 206 may select an appropriate one of the multiple selectable content presentation options designated by account settings of the associated user profile.

FIG. 3 illustrates another example processing device 300 with features for self-regulating UI architecture based on sensed environmental attributes of a three-dimensional scene. The processing device 300 includes at least a display (not shown) and one or more environmental sensors 310 for collecting data from a surrounding environment to gather information about the three-dimensional scene. The processing device 300 additionally includes memory 304 storing an environment-sensing display content regulator 306, which performs tasks for adjusting content displayed and/or selecting content for display based on an analysis of data collected by the environmental sensors 310.

When the environment-sensing display content regulator 306 is actively presenting certain application window content, the environment-sensing display content regulator 306 receives and analyzes data collected by the environmental sensors 310 to identify environmental attributes of the three-dimensional scene. Based on the identified environmental attributes, the environment-sensing display content regulator 306 selects one of multiple selectable content presentation options 302 that provides a particular selection of content related to the application window content being presented at the time the associated environmental data is collected.

In the illustrated example, the environment-sensing display content regulator 306 actively analyzes scene data while the processing device 300 is playing a main content segment 320. The main content segment 320 includes a series of frames of advertising material. This advertising material is associated in memory with other alternative content segments 322, 324, and 326 that each include one or more frames excluded from the main content segment 320.

In one implementation, the main content segment 320 is a default advertising loop that is presented by the processing device 300. For example, the processing device 300 may be a large-screen display in a store window or shopping center that actively collects scene data (e.g., imagery of pedestrians coming and going) while the main content segment 320 is played in a repeated fashion.

Each of the alternative content segments 322, 324, and 326 includes a different selection of advertising content having a topical nexus to some information (e.g., one or more frames) of the main content segment 320. For example, the main content segment 320 is shown to include a frame 328 advertising a general sale on kitchen appliances, while the alternative content segment 322 includes more detailed information on the sales of specific kitchen items. Likewise, the main content segment 320 is shown to include frames 330 and 332 generally advertising sales on “accessories” and “furniture”, while the alternative content segment 324 includes more detailed information on the specific accessories that are on sale and the alternative content segment 326 includes more detailed information about the sales on specific furniture items.

In one implementation, the main content segment 320 and the alternative content segments 322, 324, and 326 are all different segments of a same file, such as a video. In another implementation, the main content segment 320 and the alternative content segments 322, 324, and 326 are different files associated with one another in memory as a result of a pre-defined topical nexus between them.

In the example of FIG. 3, the environment-sensing display content regulator 306 includes a user presence detector 308 and a content segment selector 312. The user presence detector 308 analyzes the received data from the environmental sensor(s) 310 to identify one or more users present in the scene and to characterize one or more user presence factors. As explained with respect to FIG. 1, above, user presence factors are environmental attributes relating to physical characteristics of a user, such as characteristics that describe appearance of a user, location of a user, or motion of a user (e.g., user actions). For example, user presence characteristics may include factors such as the number of users in the scene, the height of one or more users, the distance of one or more users from the display, the length of time that one or more users have been in a stationary location and/or proximity of the display, the velocity of the users (e.g., if users are walking past), gestures of one or more users and/or physical characteristics such as gender, approximate age, etc.

The content segment selector 312 selects between different content segments (e.g., the main content segment 320 and the alternative content segments 322, 324, and 326) based on pre-defined criteria (e.g., rules) associated with different detectable user presence factors.

In one implementation, the content segment selector 312 analyzes the collected scene data to assess user proximity and/or a length of time for which a user is detected within a threshold distance of the processing device 300. If, for example, the various pedestrians passing by the processing device 300 do not stop and pause near the display for a threshold amount of time (e.g., 1-2 seconds), the content segment selector 312 continues to play the main content segment 320. If, however, a passerby pauses within a threshold proximity of the processing device 300 for some amount of time satisfying a threshold, the content segment selector 312 may switch between the main content segment 320 and one of the alternative content segments 322, 324, 326.

In one such implementation, the content segment selector 312 selects one of the alternative content segments 322, 324, and 326 that has a topical nexus to the information presented on the display at the time that the user paused to look at the display. If, for example, a user pauses (e.g., stops walking) when the display is presenting the frame 330 of the main content segment 320 (e.g., the “All Accessories Up to 35% off” frame), the content segment selector 312 may select the alternative content segment 324 (e.g., the segment pertaining to specific accessories that are on sale) for presentation. In this implementation, body language of the passerby suggests a potential interest to information included within the frame 330, and the content segment selector 312 selects the alternative content segment having the topical nexus to the information on the frame 330.

Although the illustrated example is specific to advertising material, the same selection concepts may be employed for other types of content. In one implementation the processing device 300 is a large-screen display device in a public place that provides educational information or resource assistance. For example, the processing device 300 may be located at a museum and programmed to present content about a particular exhibit or museum artifact. In this example, the main content segment 320 may be a single still-frame or a series of frames including general information such as a title, artist, and date of the museum artifact, which remains on display until one or more user presence factors are detected. If, for example, a user pauses in proximity of the processing device 300 for threshold period of time, the content segment selector 312 may selectively toggle to one of the associated alternative content segments, such as to tell a story about the history of the exhibit or artifact.

In still another implementation, the content segment selector 312 analyzes the collected scene data to assess demographic characteristics of a user detected within a threshold distance of the processing device 300. If, for example, a child stops to view the display, the content segment selector 312 may switch to a content segment that is pre-identified as likely to be of interest to a child. If an elderly person pauses to view the display, the content segment selector 312 may switch to a content segment that is pre-identified as likely to be of interest to senior citizen.

In yet still another implementation, the content segment selector 312 analyzes the collected scene data to assess the relative velocities of objects or people within the scene and selects the content to present based on one or more detected velocities. For example, the processing device 300 may be a large billboard, such as a highway billboard. When cars are moving by at high velocities, passengers in those vehicles have a short amount of time to read content presented on the billboard. In contrast, passengers in slower-moving vehicles (e.g., vehicles stuck in bad traffic) have a longer amount of time to read the content present on the billboard. If the processing device 300 detects that objects (e.g., people and/or cars) are moving in excess of a threshold velocity, the content segment selector 312 may present a first content segment that has fewer frames and/or less content to read than a second content segment that the content segment selector 312 selects responsive to a determination that the objects are moving at a velocity slower that the threshold velocity.

In any or all of these implementations specifically described with respect to FIG. 3, the environment-sensing display content regulator 306 may selectively format the selected content segment based on one or more user presence factors as well, including without limitation factors such as height and/or detected distance from the display.

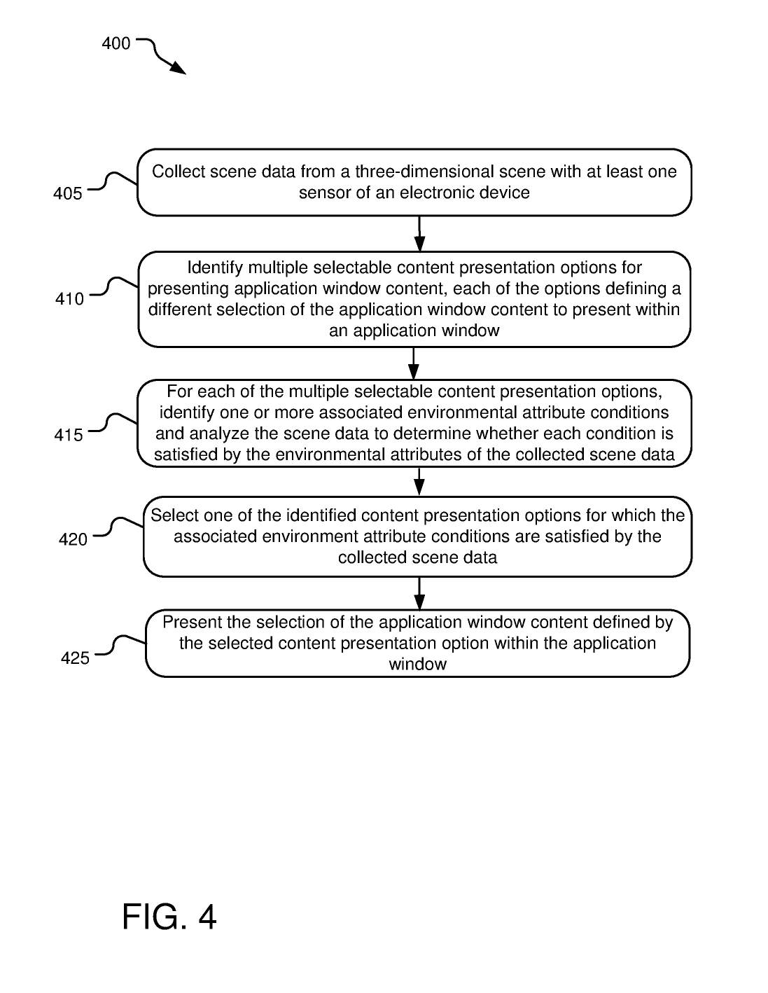

FIG. 4 illustrates example operations 400 for self-regulating UI architecture based on sensed environmental attributes of a three-dimensional scene. A collecting operation 405 collects scene data from the three-dimensional scene via at least one sensor of an electronic device. An identification operation 410 identifies multiple selectable content presentation options for presenting application window content, each of the options defining a different selection of the application window content to present within an application window. An identification and analysis operation 415 identities one or more environmental attribute conditions associated in memory with each of the identified multiple selectable content presentation options and analyzes the scene data to determine whether each condition is satisfied by the environmental attributes of the collected scene data. A selection operation 420 selects one of the multiple selectable content presentation options for which the associated environmental attribute condition(s) are satisfied by the collected scene data, and a presentation operation 425 presents the selection of application window content defined by the selected content presentation option within the application window.

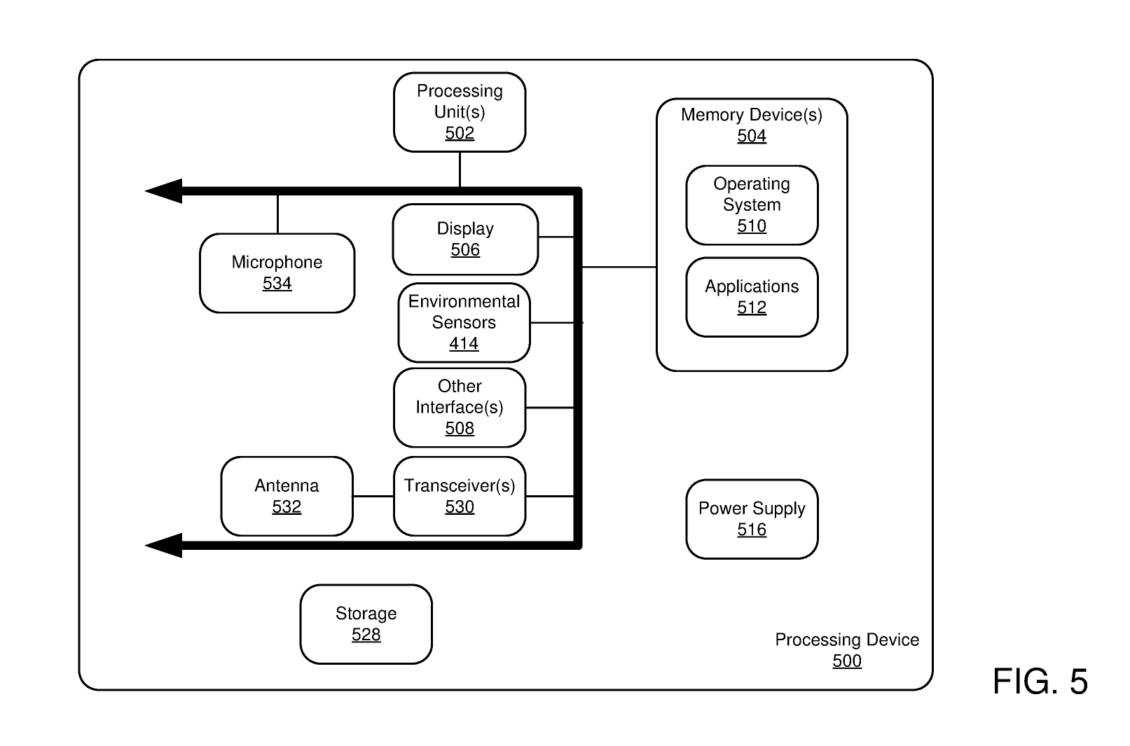

FIG. 5 illustrates an example schematic of a processing device 500 suitable for implementing aspects of the disclosed technology. The processing device 500 includes one or more processing unit(s) 502, one or more memory devices 504, a display 506, which may be a touchscreen display, and other interfaces 508 (e.g., buttons). The processing device 500 additionally includes environmental sensors 514, which may include a variety of sensors including without limitation sensors such as depth sensors (e.g., lidar, RGB, radar sensors), cameras, touchscreens, and infrared sensors. The memory devices 504 generally includes both volatile memory (e.g., RAM) and non-volatile memory (e.g., flash memory). An operating system 510, such as the Microsoft Windows® operating system, the Microsoft Windows® Phone operating system or a specific operating system designed for a gaming device, resides in the memory devices 504 and is executed by the processing unit(s) 502, although other operating systems may be employed.

One or more applications 512, such as the environment-sensing display content regulator 106, 206, or 306 of FIG. 1-3, respectively, are loaded in the memory device(s) 504 and are executed on the operating system 510 by the processing unit(s) 502. The processing device 500 includes a power supply 516, which is powered by one or more batteries or other power sources and which provides power to other components of the processing device 500. The power supply 516 may also be connected to an external power source that overrides or recharges the built-in batteries or other power sources.

The processing device 500 includes one or more communication transceivers 530 and an antenna 532 to provide network connectivity (e.g., a mobile phone network, Wi-Fi®, BlueTooth®). The processing device 500 may also include various other components, such as a positioning system (e.g., a global positioning satellite transceiver), one or more accelerometers, one or more cameras, an audio interface (e.g., a microphone 534, an audio amplifier and speaker and/or audio jack), and storage devices 528. Other configurations may also be employed. In an example implementation, various applications are embodied by instructions stored in memory device(s) 504 and/or storage devices 528 and processed by the processing unit(s) 502. The memory device(s) 504 may include memory of host device or of an accessory that couples to a host.

The processing device 500 may include a variety of tangible computer-readable storage media and intangible computer-readable communication signals. Tangible computer-readable storage can be embodied by any available media that can be accessed by the processing device 500 and includes both volatile and nonvolatile storage media, removable and non-removable storage media. Tangible computer-readable storage media excludes intangible and transitory communications signals and includes volatile and nonvolatile, removable and non-removable storage media implemented in any method or technology for storage of information such as computer readable instructions, data structures, program modules or other data. Tangible computer-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information and which can be accessed by the processing device 500. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include wired media such as a wired network or direct-wired connection, and wireless media such as acoustic, RF, infrared and other wireless media.

Some embodiments may comprise an article of manufacture. An article of manufacture may comprise a tangible storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

An example method disclosed herein includes collecting scene data from a three-dimensional scene with at least one sensor of an electronic device and selecting, with a processor, a content presentation option of multiple selectable content presentation options based on the collected scene data. Each of the multiple selectable content presentation options defines a different selection of content to present within an application window of the electronic device. The method further includes presenting the content selection defined by the selected content presentation option within the application window on a display of the electronic device.

An example method of any preceding method includes analyzing the collected scene data to detect at least one user presence factor and selecting the content presentation option based on the detected at least one user presence factor.

In still another example method of any preceding method, the at least one user presence factor includes a detected distance between a user and a screen.

In yet another example method of any preceding method, the at least one user presence factor includes a detected velocity of a user in the three-dimensional scene.

In still another example method of any preceding method, the at least one user presence factor includes a measured amount of time that a user has been detected within a threshold proximity of the electronic device.

In another example method of any preceding method, a first one of the content presentation options defines first content and a second one of the content presentation options defines second content consisting of a subset of the first content.

In still another example method of any preceding method, the method further includes detecting at least one room dimension and selecting the content presentation option based on the at least one detected dimension.

In still another example method of any preceding method, each of the multiple selectable content presentation options defines a different content loop.

In another example method of any preceding method, each of the multiple selectable content presentation options provides for a different selection of user interface elements of an application associated with the application window.

An example system disclosed herein includes a means for collecting scene data from a three-dimensional scene with at least one sensor of an electronic device and a means for selecting a content presentation option of multiple selectable content presentation options based on the collected scene data. Each of the multiple selectable content presentation options defines a different selection of content to present within an application window of the electronic device. The system further includes a means for presenting the content selection defined by the selected content presentation option within the application window on a display of the electronic device.

An example electronic device disclosed herein includes one or more environmental sensors and an environment-sensing display content regulator. The environment-sensing display content regulator is stored in the memory and executable to collect scene data from the one or more environmental sensors and to select a content presentation option of multiple selectable content presentation options based on the collected scene data, where each of the multiple selectable content presentation options defining a different selection of content to present within an application window of the electronic device. The environment-sensing display content regulator is further executable to present the content selection defined by the selected content presentation option within the application window on a display of the electronic device.

In another example electronic device according to any preceding electronic device, the environment-sensing display content regulator is further executable to analyze the collected scene data to detect at least one user presence factor and to select the content presentation option based on the detected at least one user presence factor.

In another example electronic device according to any preceding electronic device, the at least one user presence factor includes a detected distance between a user and a screen.

In still another example electronic device according to any preceding electronic device, the at least one user presence factor includes a detected velocity of a user.

In still another example electronic device of any preceding electronic device, the at least one user presence factor includes a measured amount of time that a user has been detected within a threshold proximity of the electronic device.

In another example electronic device of any preceding electronic device, a first one of the content presentation options defines first content and a second one of the content presentation options defines second content consisting of a subset of the first content.

In still another example electronic device of any preceding electronic device, the environment-sensing display content regulator is further executable to detect at least one room dimension; and select the content presentation option based on the at least one detected room dimension.

In still another example electronic device of any preceding electronic device, each of the multiple selectable content presentation options defines a different content loop.

In another example electronic device of any preceding electronic device, each of the multiple selectable content presentation options provides for a different selection of user interface elements an application associated with the application window.

An example method disclosed herein includes collecting scene data from a three-dimensional scene with at least one sensor on an electronic device and determining, with a processor, at least one physical dimension of a room within the three-dimensional scene based on the collected scene data. The method further includes selecting a content presentation option of multiple selectable context presentation options based on the at least one determined physical dimension and presenting the application window content on a display of the electronic device according to the selected content presentation option. Each of the multiple selectable content presentation options is associated with a different representation of application window content.

In an example method of any preceding method, each of the multiple selectable content presentation options is associated with a different size of individual content elements included within the application window content.

An example system disclosed herein includes a means for collecting scene data from a three-dimensional scene with at least one sensor on an electronic device and a means for determining at least one physical dimension of a room within the three-dimensional scene based on the collected scene data. The system further includes a means for selecting a content presentation option of multiple selectable context presentation options based on the at least one determined physical dimension and a means for presenting the application window content on a display of the electronic device according to the selected content presentation option. Each of the multiple selectable content presentation options is associated with a different representation of application window content.

The above specification, examples, and data provide a complete description of the structure and use of exemplary embodiments of the invention. Since many implementations of the invention can be made without departing from the spirit and scope of the invention, the invention resides in the claims hereinafter appended. Furthermore, structural features of the different embodiments may be combined in yet another implementation without departing from the recited claims.

1. A method comprising:
collecting scene data from a three-dimensional scene with at least one sensor of an electronic device;
selecting, with a processor, a content presentation option of multiple selectable content presentation options based on the collected scene data, each of the multiple selectable content presentation options defining a different selection of content to present within an application window of the electronic device, the multiple content presentation options including a first presentation option defining first content and a second presentation option defining second content, the second content defining a subset of the first content and including fewer content elements than the first content; and
presenting the content selection defined by the selected content presentation option within the application window on a display of the electronic device.

2. The method of claim 1, further comprising:
analyzing the collected scene data to detect at least one user presence factor; and
selecting the content presentation option based on the detected at least one user presence factor.

3. The method of claim 2, wherein the at least one user presence factor includes a detected distance between a user and a screen.

4. The method of claim 2, wherein the at least one user presence factor includes a detected velocity of a user in the three-dimensional scene.

5. The method of claim 2, wherein the at least one user presence factor includes a measured amount of time that a user has been detected within a threshold proximity of the electronic device.

6. The method of claim 1, wherein a first one of the content presentation options defines first content and a second one of the content presentation options defines second content consisting of a subset of the first content.

7. The method of claim 1, further comprising:
detecting at least one room dimension and selecting the content presentation option based on the at least one detected room dimension.

8. The method of claim 1, wherein each of the multiple selectable content presentation options defines a different content loop.

9. The method of claim 1, wherein each of the multiple selectable content presentation options provides for a different selection of user interface elements of an application associated with the application window.

10. An electronic device comprising:
memory;
a processor;
one or more environmental sensors; and
an environment-sensing display content regulator stored in the memory and executable by the processor to:
collect scene data from the one or more environmental sensors;
select a content presentation option of multiple selectable content presentation options based on the collected scene data, each of the multiple selectable content presentation options defining a different selection of content to present within an application window of the electronic device, the multiple content presentation options including a first presentation option defining first content and a second presentation option defining second content, the second content defining a subset of the first content and including fewer content elements than the first content; and
present the content selection defined by the selected content presentation option within the application window on a display of the electronic device.

11. The electronic device of claim 10, wherein the environment-sensing display content regulator is further executable to:
analyze the collected scene data to detect at least one user presence factor; and
select the content presentation option based on the detected at least one user presence factor.

12. The electronic device of claim 11, wherein the at least one user presence factor includes a detected distance between a user and a screen.

13. The electronic device of claim 11, wherein the at least one user presence factor includes a detected velocity of a user.

14. The electronic device of claim 11, wherein the at least one user presence factor includes a measured amount of time that a user has been detected within a threshold proximity of the electronic device.

15. The electronic device of claim 10, wherein a first one of the content presentation options defines first content and a second one of the content presentation options defines second content consisting of a subset of the first content.

16. The electronic device of claim 10, wherein the environment-sensing display content regulator is further executable to:
detect at least one room dimension; and
select the content presentation option based on the at least one detected room dimension.

17. The electronic device of claim 10, wherein each of the multiple selectable content presentation options defines a different content loop.

18. The electronic device of claim 10, wherein each of the multiple selectable content presentation options provides for a different selection of user interface elements an application associated with the application window.

19. A method comprising:
collecting scene data from a three-dimensional scene with at least one sensor on an electronic device;
determining, with a processor, at least one physical dimension of a room within the three-dimensional scene based on the collected scene data; and
selecting a content presentation option of multiple selectable context presentation options based on the at least one determined physical dimension of the room, each of the multiple selectable content presentation options associated with a different representation of application window content, the multiple content presentation options including a first presentation option defining first content and a second presentation option defining second content, the second content defining a subset of the first content and including fewer user interface elements than the first content; and
presenting the application window content on a display of the electronic device according to the selected content presentation option.

20. The method of claim 19, each of the multiple selectable content presentation options is associated with a different size of individual content elements included within the application window content.
